(19) United States
(12) Patent Application Publication
(10) Pub. No.: US 2005/0050759 A1
(43) Pub. Date: Mar. 10, 2005

(54) Efficient and cost-effective biomass drying

(75) Inventors: Ravi Chandran, Ellicott City, MD (US); Momtaz N. Mansour, Highland, MD (US)

Correspondence Address: Dority & Manning, P.A., P.O. Box 1449, Greenville, SC, 29601, US

(73) Assignee: Manufacturing and Technology Conversion International, Inc.

(21) Appl. No.: 10/916,224

(22) Filed: Aug. 11, 2004

Related U.S. Application Data
(60) Provisional application No. 60/494,536, filed on Aug. 11, 2003.

(51) Int. Cl. F26B 7/00; F26B 17/00

(52) U.S. Cl. 34/576

(57) ABSTRACT

Disclosed is a pulsed dryer and a pulsed drying system. The dryer includes a pulse combustor fluid dynamically coupled to a drying chamber. The pulsed dryer can be any suitable type of dryer, for example a pulsed spray dryer or a pulsed fluid bed dryer. The pulse combustor can fire the dried fines or employ auxiliary fuel such as natural gas, propane, etc. The system can include a steam or heat transfer fluid thermal circuit for providing heat to the drying chamber and optionally for cooling the pulse combustor flue gases prior to flow into the drying chamber. The disclosed dryers and systems can be advantageously utilized for wet feedstock in general and in particular for drying biomass or other organic type feedstock.

### CROSS REFERENCE TO RELATED APPLICATION

This application claims benefit to U.S. Provisional Application having Ser. No. 60/494,536 filed Aug. 11, 2003.

### FEDERALLY SPONSORED RESEARCH AND DEVELOPMENT

The United States Government may have rights in this invention pursuant to SBIR/STTR Grant No. DEFG02-03ER83707.

### BACKGROUND OF THE INVENTION

The world primary energy consumption in 1991 was about 347 Quad Btu. According to the International Energy Agency (IEA), the world primary energy demand in 2010 is anticipated to be on the order of 460 Quad Btu. The strongest growth in energy demand is projected to occur in Asia. This growth is likely to increase global emissions albeit to a greater or lesser extent depending on the energy conversion technologies employed. Additionally, waste generation rate and the environmental impact associated with waste disposal are likely to increase with further industrialization. One way to minimize adverse environmental impact and promote sustainable development is to enhance biomass utilization. Biomass is reported to account for about 14% of the global energy supply. Efficient use of biomass could extend national resources, reduce fuel imports and improve/sustain the global environment.

Concurrent with the demand for primary energy is the growth in demand for electricity, transportation fuels and chemicals. In an attempt to fast forward biopower commercialization, the U.S. Department of Energy (DOE), National Renewable Energy Laboratory (NREL), National Energy Technology Laboratory (NETL) and Oak Ridge National Laboratory (ORNL) are actively pursuing the development and demonstration of biomass gasification, advanced gas turbines, fuel cells, combined cycle, combined heat and power technologies, liquid fuels production and dedicated feedstock supply systems. This in conjunction with the Executive Order on Biobased Products and Bioenergy and the goal of tripling U.S. use of biobased products and bioenergy by 2010, provides impetus for developing advanced biomass conversion systems.

Typically, biomass refers to carbonaceous materials derived from plants, dedicated energy crops and animals with differing composition, moisture content, inorganic matter and local availability. Examples include agricultural residues (stalks, straw, etc.), agricultural wastes (sugar cane bagasse, orchard prunings, etc.), sawmill wastes, forest residues, energy crops (poplars, switchgrass, willow, etc.), co-utilization crops (alfalfa), and livestock wastes (from dairy, hog and poultry farms). All these materials represent a vast energy source that can potentially displace conventional fossil fuels, reduce carbon emissions and mitigate climate change. For instance, the world sugar cane bagasse production in 1989 was reported to be about 270 million short tons per year. The World Energy Council estimated that the bagasse could generate globally about 50 GW of electricity. The U.S. production of bagasse was reported as approximately 11 million short tons per year. In comparison, the estimates for forestry waste, mill waste and urban waste in the U.S. exceed 86 million short tons per year. It is estimated that between 15 and 20 Quad Btu of gross energy could be derived annually from all of the biomass generated in the United States. Considering that the total U.S. energy consumption is on the order of 90 Quad Btu per year, this represents a significant opportunity for enhanced biomass utilization.

Biomass utilization is also characterized by an economical, local transportation radius. The lower the moisture content and higher the energy density of the biomass, the larger the possible transportation radius and the greater the ease of handling and storage. Biomass densification or briquetting has been suggested as a means to improve the efficiency of biomass utilization and reduce air pollution. The upper limit on moisture content for prolonged safe storage or densification of biomass is about 15 percent. Many different advanced biomass conversion systems are under various stages of development. The efficiency and economics of these systems generally improve with a reduction in the moisture content of the biomass feed. Biomass typically has high moisture content and therefore requires drying. Dryer classification runs the gamut of direct or indirect (based on the method of heating), once through or recycle (gas flow) and flue gas, steam or air (heating medium). Generally, rotary, flash and superheated steam dryers are the main choices for biomass drying. Each of these dryers offers specific benefits but also suffers from certain drawbacks or deficiencies, in particular in regard to drying effectiveness, energy efficiency, fire safety, environmental impact, and capital and operating costs. There is a need for a more versatile dryer with greater benefits and fewer disadvantages as compared to those for the rotary, flash and superheated steam dryers.

Many drying systems for drying a slurry feed utilize spray dryers. Conventional atomizers used in commercial spray dryers can generally be classified into three types, namely, pressure nozzle, pneumatic two-fluid and centrifugal. All of these systems require energy input and require periodic maintenance, both of which add to the cost of the system. The pressure nozzle type requires the least energy input of the three. This system produces a narrow droplet size distribution. But propensity for plugging, erosion, and wear is high. Also, the dryer needs to be tall to accommodate the high velocity spray and provide sufficient residence time for drying. The pneumatic two-fluid atomizer generally does not require a high-pressure pump and can use a smaller drying chamber. But the use of compressed air renders it energy intensive and the formation of an air boundary layer around the droplet can impede heat and mass transfer with the hot gas. The centrifugal or rotary atomizer is the most common type and can service high evaporation capacity. However, the need for a large diameter-drying chamber increases capital cost of these systems. A relatively high gas inlet velocity is required to prevent wall build-up or mud ring and this can increase fines/dust generation. A dispenser is required to bring the hot gas in contact with the droplets. The hot gas temperature is usually limited to 800° F. (427° C.) to protect bearings and this further increases airflow. Periodic maintenance is also required due to high-speed operation. Large gas flow increases dust collector size and cost as well.

In addition, typically, dryers employ premium fossil fuel as a heat source. There is possibility, however, for the efficient and economical utilization of biomass as the energy source for drying.

There is a need for the development of a feedstock-flexible, modular, biomass drying system that can cater to the local market drivers in an efficient, economical, safe and environmentally responsible manner. Deployment of such drying systems can enhance biomass utilization, promote energy savings and reduce pollutant emissions.

### SUMMARY OF THE INVENTION

In one embodiment, the present invention is directed to a pulsed dryer for drying biomass. The dryer of the invention can include a drying chamber and a pulse combustor fluid dynamically coupled to the drying chamber such that the flue gas from the pulse combustor can flow through the drying chamber and create an oscillating velocity field in the drying chamber due to the acoustics generated during pulse combustion. In one embodiment, the pulse combustor can be coupled to the drying chamber via a resonance tube. In one particular embodiment, the pulse combustor can be acoustically coupled to the drying resonant chamber.

The dryer of the invention can include a feed inlet for feeding a wet biomass feedstock to the dryer. The location of the feed inlet can depend upon the type of dryer. For example, in one embodiment, the dryer can be a pulsed spray dryer and the feed inlet can be just downstream of the pulse combustor, so the feedstock can be atomized by the pulse combustor flue gas.

In another embodiment, the dryer can be a pulsed fluid bed dryer, and the feed inlet can direct the biomass feedstock into the splash zone or the dense bed region of the fluid bed. For example, the feedstock can include particles up to about two inches in diameter with an appropriately designed fluid bed.

In one embodiment, the disclosed invention is directed to a drying system. The drying system includes a feed inlet for conveying feedstock, e.g., a biomass or organic slurry, to a drying chamber, a product outlet for removing dried product from the drying chamber, and a pulse combustor fluid dynamically coupled to the drying chamber via the pulse combustor tailpipe. In the particular embodiment wherein the drying chamber is a fluid bed, the pulse combustor can be coupled to the drying chamber via the inlet plenum of the fluid bed.

The drying system can also include a solids separation device for separating fines from the dried product. In one embodiment, the dried fines can be circulated via a suitable path and used as fuel to fire the pulse combustor, supplying the energy for drying.

The drying system of the present invention can also include an indirect heating circuit that can provide heat to the drying chamber. An indirect heating circuit can also be used to remove heat from the pulse combustor tailpipe or resonance tube(s) and to cool/temper the pulse combustor flue gases prior to entering the fluid bed dryer inlet plenum. The indirect heating circuit can utilize any suitable heat transfer fluid. For example, the indirect heating circuit can utilize a steam/water circuit or a gas, such as air or a heat transfer fluid or thermofluid.

In one embodiment, the system of the invention can produce a dried product having a moisture content of less than about 20%. In another embodiment, the dried product can have a moisture content of less than about 15%. In another embodiment, the dried product can have a moisture content of less than 10%.

### BRIEF DESCRIPTION OF THE FIGURES

A full and enabling disclosure of the present invention, including the best mode thereof, to one of ordinary skill in the art, is set forth more particularly in the remainder of the specification, including reference to the accompanying figures in which:

FIG. 1 is a schematic of a prior art pulsed spray drying system;

FIG. 2 is a schematic of one embodiment of a pulsed spray drying system of the present invention;

FIG. 3 is a schematic of another embodiment of a pulsed spray drying system of the present invention;

FIG. 4 is a schematic of a pulsed fluid bed drying system of the present invention;

FIG. 5 graphically illustrates flue gas emissions of one configuration of a natural gas-fired pulse combustor;

FIGS. 6-10 graphically illustrate results of Example 3; and

FIG. 11 tabulates the test data from Example 3.

Repeat use of reference characters in the present specification and drawings is intended to represent the same or analogous features or elements of the present invention.

### DETAILED DESCRIPTION OF THE INVENTION

Reference will now be made in detail to various embodiments of the invention, one or more examples of which are set forth below. Each embodiment is provided by way of explanation of the invention, not limitation of the invention. In fact, it will be apparent to those skilled in the art that various modifications and variations may be made in the present invention without departing from the scope or spirit of the invention. For instance, features illustrated or described as part of one embodiment, may be used in another embodiment to yield a still further embodiment. Thus, it is intended that the present invention cover such modifications and variations as come within the scope of the appended claims and their equivalents.

In general, the present invention is directed to pulsed dryers and systems utilizing the disclosed pulsed dryers. For example, the dryers of the present invention can be utilized for drying wet feedstock (e.g., about 50 wt % water) to a moisture content of less than about 20%. In one embodiment, the disclosed dryers can dry wet feedstock to a final moisture content of less than about 15%. In another embodiment, the disclosed dryers can dry wet feedstock to a final moisture content of less than 10%, for example, between about 0.2% and about 5% moisture content.

The disclosed pulsed dryers can provide superior heat and mass transfer and combustion as compared to conventional dryers. The disclosed pulsed dryers can additionally promote energy savings with reduced environmental impact and associated costs. In one embodiment, the disclosed pulse dryers can be pulsed spray dryers In another embodiment, the pulse dryers can be pulsed fluid bed dryers

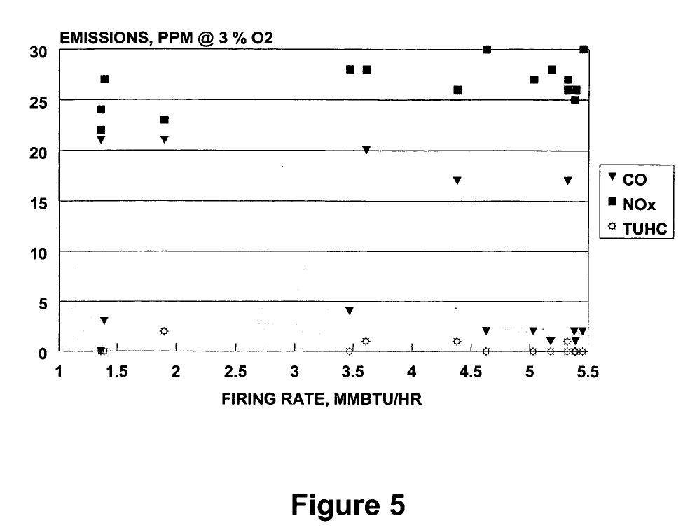

Pulse combustion is a high-efficiency combustion process characterized by low gaseous emissions (NOₓ, CO and THC). For example, with natural gas firing, the emissions of NOₓ, CO and THC are typically less than 30, 20, and 2 ppmv, respectively, when corrected to 3% O₂, as is illustrated for the particular case of NOₓ emissions in Example 1 and FIG. 5. Additionally, many pulse combustors are fluid-dynamic devices and do not feature mechanical moving parts. This can provide long life and high levels of reliability, availability, and maintainability.

Pulse combustors are also capable of self-aspiration and pressure boost, enabling the Forced Draft fan static head and power input to be reduced. For instance, investigators have observed pressure boost due to combustion in a variety of Helmholtz pulse combustors available from Manufacturing and Technology Conversion International, Inc., of Baltimore, Md., USA. Table 1, below, provides sample results. As can be seen, the pressure gain or boost for pulse combustors can be significant and, in this instance, was as high as 3 percent based on the absolute inlet pressure. As clearly illustrated in the data, one of the benefits of using a pulse combustor as a substitute for a steady flow combustor is to obtain an increase in stagnation pressure without moving parts, as distinct from the customary pressure loss between the combustor inlet and combustor outlet with conventional systems.

TABLE 1
Pressure Gain of Pulse Combustors

| | | | BENCH-SCALE | LAB-SCALE |
|---|---|---|---|---|
| | | COMMERCIAL | ELEVATED | ELEVATED |
| COMBUSTOR | COMPACT | SCALE | PRESSURE | PRESSURE |
| Firing Rate, | 3.0 | 5.0 | 0.9 | 3.0 |
| MMBtu/h | | | | |
| Static Pressure | −1.8 | 8 | 73 psig | 18.2 psig |
| in Air Plenum | “H₂O g | “H₂O g | | |
| Static Pressure | 5.1 | 9 | 75 psig | 19.2 psig |
| in Combustor | “H₂O g | “H₂O g | | |
| Pressure Gain, % | 1.7 | 0.4 | 2.3 | 3.0 |

Examples of pulse combustors such as may be utilized in the disclosed drying systems are disclosed in the following U.S. patents, all of which are incorporated by reference thereto in their entirety: U.S. Pat. No. 5,059,404 issued Oct. 22, 1991, to Mansour, et al., U.S. Pat. No. 5,133,297 issues Jul. 28, 1992, to Mansour, U.S. Pat. No. 5,197,399 issued Mar. 30, 1993 to Mansour, U.S. Pat. No. 5,205,728 issued Apr. 27, 1993, to Mansour, U.S. Pat. No. 5,211,704 issued May 18, 1993, to Mansour, U.S. Pat. No. 5,255,634 issued Oct. 26, 1993, to Mansour, U.S. Pat. No. 5,306,481 issued Apr. 26, 1994, to Mansour, et al., U.S. Pat. No. 5,353,721 issued Oct. 11, 1994, to Mansour, et al., U.S. Pat. No. 5,366,371 issued Nov. 22, 1994, to Mansour, et al., U.S. Pat. No. 5,536,488 issued Jul. 16, 1996, to Mansour, et al., U.S. Pat. No. 5,637,192 issued Jun. 10, 1997, to Mansour, et al., U.S. Pat. No. 5,638,609 issued Jun. 17, 1997, to Chandran, et al., and U.S. Pat. No. 5,842,289 issued Dec. 1, 1998, to Chandran, et al.

The particle drying rate in particle drying operations varies with time and/or moisture content and generally can be classified into two periods following the initial warm-up, namely, a constant-rate period exhibiting a zero-order drying rate and a falling-rate period exhibiting a first-order drying rate. The falling-rate period can be characterized initially by moisture diffusion away from the evaporative surface and later by the rate of internal moisture departure. The drying rate during this period can be influenced by proper atomization and gas-solid contacting scheme.

Based on the dynamic equilibrium between heat transfer to the droplet and mass transfer from the droplet during the constant-rate period, the following equation can be written for the drying rate:
dw/dt=hA_{d}ΔT/Lₑ=kₘA_{d}ΔP
where:
dw/dt represents the rate of drying,
w represents the moisture content at any time,
h represents the total heat transfer coefficient,
ΔT represents the temperature difference between the gas and the droplet surface,
A_{d} represents the surface area of the droplet,
Lₑ represents the latent heat of evaporation,
kₘ represents the mass transfer coefficient, and
ΔP represents the difference in vapor pressure of water at droplet surface temperature and the partial pressure of water vapor in the hot gas.

As can be seen from this description, the drying rate can be enhanced, which can lead to a corresponding decrease in drying chamber size and operational costs, by increase in heat and/or mass transfer coefficient, increase in droplet surface area (which in turn is influenced by atomization effectiveness in the case of spray drying), increase in hot gas temperature, and/or decrease in water vapor partial pressure in the hot gas. All of these factors can be governed by the gas droplet/solid contacting scheme or the flow field attributes, the degree of atomization, the properties of the feed, and the product requirements. Of course, the process will also generally be configured so as to prevent thermal or mechanical degradation of the material to be dried.

The pulsed drying environment of the present invention can provide marked improvement in atomization and/or gas-droplet/solid contact and can in turn enhance the drying rate and effectiveness of the process. For instance, a pulsating or oscillating flow field can periodically scrub the boundary layer around a particle by virtue of flow reversal. A pulsating or oscillating flow field can also reduce film resistance and enhance heat and mass transfer of a particle. Many studies have confirmed the benefits of pulsations on transport phenomenon. For example, Larsen and Jensen (“Evaporation Rate of Drops in Forced Convection with Superposed Transferses Sound Field,” International Journal of Heat and Mass Transfer, 12, 511-517 (1978)) report an improvement of up to 90% in the Sherwood number (dimensionless mass transfer parameter) in the evaporation rate of a single droplet of water in a sound field. Ha and Yavuzkurt (“A Theoretical Investigation of Acoustic Enhancement of Heat and Mass Transfer-II. Oscillating Flow with a Steady Velocity Component,” International Journal of Heat and Mass Transfer, 36, 2193-2202 (1993)) also reported enhancement in heat and mass transfer due to acoustics. They found the enhancement to vary with particle size and acoustic field intensity. The Sherwood and Nusselt (dimensionless heat transfer parameter) numbers generally increased with the acoustic field intensity and exhibited improvements up to 250%.

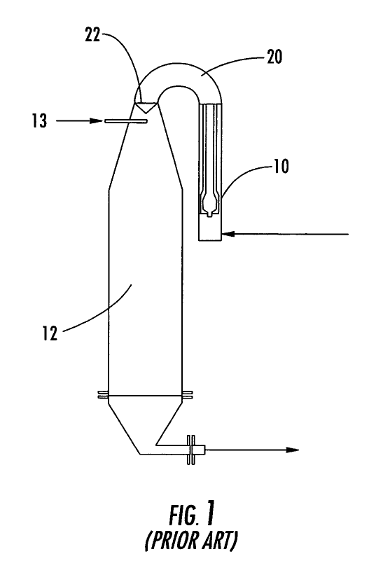

FIG. 1 schematically illustrates a previously known pulsed combustor apparatus as described in U.S. Pat. No. 5,638,609 to Chandran, et al., previously incorporated by reference. The illustrated pulse combustion drying apparatus couples a pulse combustion device 10 with a drying chamber 12. For instance, the pulse combustor 10 can be acoustically coupled with the drying chamber by means of a resonance chamber 20 and a nozzle 22. In particular, the resonance chamber 20 can be fashioned so as to promote formation of a standing wave with a pressure anti-node upstream of the drying chamber. The described pulse combustion drying apparatus is described as suitable for high temperature drying and recovery of solid materials as well as to reduce the volume and amount of wastes. The disclosed dryer could be used to dry, for instance, chemicals, minerals, plastics, food products, pharmaceuticals, or industrial wastes. When utilizing the pulse combustion drying apparatus of FIG. 1 to dry a slurry, the previous patent teaches that a gas or liquid fuel can be used to fuel the pulse combustor.

In one embodiment, the biomass or organic waste slurry pulsed dryers of the present invention can be pulsed spray dryers. Spray drying can generally be characterized by three fundamental processes: (1) atomization of the feed slurry, (2) heat transfer to the droplet to evaporate liquid, and (3) mass transfer within the droplet/solid and from the surface. The last two steps occur simultaneously. The method of atomization, the degree of gas-droplet/solid contact and gas inlet conditions can determine the drying rate, drying effectiveness, component sizes, energy consumption and system cost. The type of burner used to generate the hot gas can impact the environmental emissions.

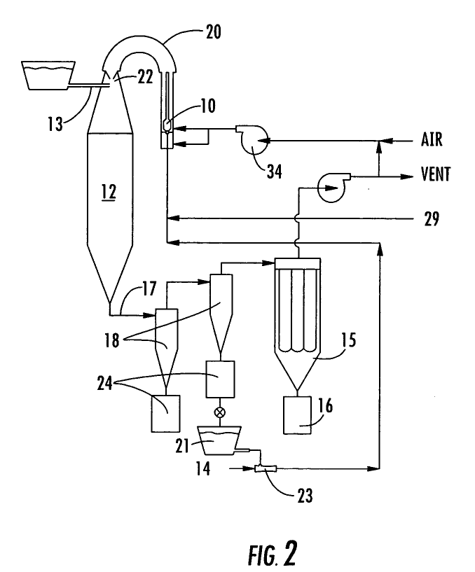

FIG. 2 shows a schematic of one embodiment of the pulsed spray dryers of the present invention. According to this embodiment, the pulsed spray dryer comprises a pulse combustion device 10 coupled to a drying chamber 12. Wet biomass feedstock to be dried can be introduced at a feed inlet 13, which, in this particular embodiment, can be just downstream of the pulse combustion device 10. As such, the pulse combustion device 10 can facilitate slurry atomization, and the present spray-drying system can be utilized without conventional high shear nozzles or spray heads. The pulsating flow environment can enhance heat and mass transfer rates, thereby aiding faster and more uniform drying and can result in superior product quality. The resonance chamber 20 can provide the transition from combustion to flue gas tempering, i.e., the combustion process can be complete before optional cooling air dilution occurs to regulate the flue gas temperature. In addition, the flue gas temperature can be controlled so as to prevent thermal degradation of the material to be dried. The maximum inlet temperature for the flue gas to the drying chamber to prevent thermal degradation of the feedstock will vary depending primarily upon the characteristics of the feedstock. In general, however, the maximum flue gas inlet temperature will be about 750° F. In one embodiment, it can be about 650° F. In another embodiment, it can be about 600° F. or about 500° F.

As shown in FIG. 2, a baghouse 15 can be included in the system and can be utilized as a particle separation device. Dry product can be withdrawn continuously from the baghouse catch 16 and other collection devices, if present. The system can be configured for either closed loop or open loop operation. If solvent recovery is desired, condensers and/or wet scrubbers can optionally be employed, as is generally known in the art. When solvent recovery is not desired, a liquid effluent stream may not be generated at all, thus, disposal or further processing of effluent will not be necessary. If necessary, the drying chamber can be configured to agglomerate a portion of the solid particles and generate both a coarse and a fine particle fraction.

The nozzle 22 can accelerate the flue gas and create a pulsating velocity head. It translates the static head into velocity fluctuations. This pulsating velocity flow field can facilitate feed stream atomization and/or enhance heat and mass transfer rates. The innovative coupling can harness the energy in the combustion-induced oscillations and the pressure boost generated by pulse combustion to facilitate atomization. This helps reduce energy input from external sources. This arrangement also ensures good gas-droplet/solid contact and mixing. Moreover, there is no requirement in the system for compressed air, any high-pressure pump, or any high-speed motor to atomize the slurry in spray-drying embodiments of the invention.

The flow diode utilized in many other pulse combustion concepts is a mechanical “flapper valve” which is a mechanical check valve or rotary valve permitting flow toward the chamber and constraining reverse flow. The disclosed pulse combustors can utilize this type of valve or alternatively can employ an aerodynamic valve without moving parts as an effective, durable alternative to the “flapper” valve. The aerovalve can facilitate operation with a wide variety of fuels and can also permit a wide tolerance of operating conditions.

According to the embodiment illustrated in FIG. 2, a feed inlet 13 can be just downstream of the pulse combustion device 10, and a slurry, e.g., a biomass or organic waste slurry including small particles, can be fed to the drying chamber 12. According to this particular embodiment, the dried solids can be entrained in the gas flow 16 out of the bottom of the drying chamber 12.

A cyclone 18, multiclone or High Efficiency Particulate Air (HEPA) filter may be employed as a particle separation device, if desired. As shown, primary and secondary cyclones 18 can be located upstream of the baghouse 15. The inclusion of a secondary cyclone 18 can generally depend upon the wet biomass feed properties (e.g., size distribution, ash content and heating value).

According to this embodiment, a portion of the dried biomass fines can be collected at a dried fines feeder 21, and transported for injection into the pulse combustor. For example, the dried biomass fines can be pneumatically transported by use of an eductor 23. In this particular embodiment, the schematics show the cyclone catch 24 of the secondary cyclone 18 being educted. Optionally, the baghouse catch 16 and/or the primary cyclone could be educted in addition to or alternative to the secondary cyclone 18 and the fines sent via a suitable path and provide a source of fuel to the pulse combustor. The preferred arrangement can depend on the properties of the wet biomass feed (size distribution, ash content and heating value). The intent is to collect a sufficient amount of dried biomass fines separate from ash to fire the pulse combustor 10 of the system or optionally to a second pulse combustor in this or another system. Specifically, firing of dried biomass fines in the pulse combustor 10 can be used to generate the flue gas and the pulsating flow field, and natural gas or propane can be used for startup and support, if necessary, which can be fed to the pulse combustor 10 via fuel inlet 29, as shown.

The utilization of recovered biomass fines to provide heat input to the system can offer several advantages. For example, the disclosed process can minimize the need for premium fossil fuels and the attendant greenhouse gas emissions and fuel costs associated with such fuels. In addition, the dry biomass product produced by the system can have a smaller proportion of fines, which can minimize fugitive dust emission, reduce fire hazard during transportation and handling of the dried product, and improve combustion or gasification performance of the product dried biomass, which can reduce emissions when the product dried biomass is used in conventional steam/power generation equipment.

The specific arrangement of the resonance chamber 20 can be designed so as to provide suitable residence time for the char generated from the biomass fines and ensure complete combustion. In addition, the design of nozzle 22 at the resonance chamber exit can be engineered so as to facilitate atomization of the slurry. In particular, for wet biomass feed, the nozzle opening can be increased to ease the demand on air supply pressure.

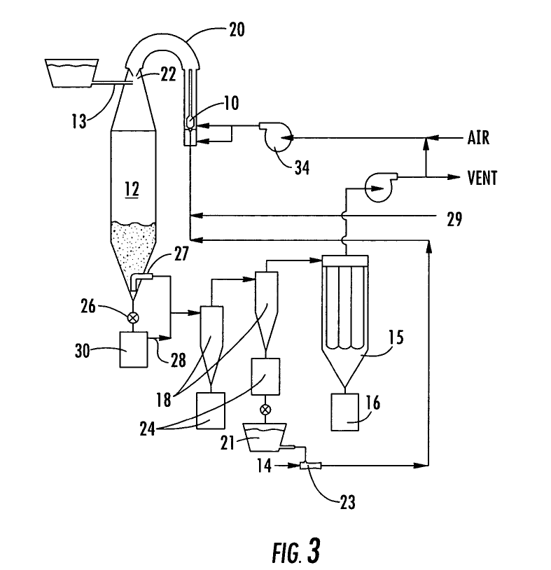

Another embodiment of a pulse spray dryer of the invention is illustrated in FIG. 3. In general, an embodiment such as that illustrated in FIG. 3 can be preferred for biomass or organic waste that includes particles up to about 1 mm in size, for example, for materials that can pass through a sieve of U.S. No. 18 size. In this embodiment, the larger dried solids can be allowed to accumulate to a height in the drying chamber 12 such that the gas flows downdraft through a fixed bed 25. A solids conveyance 26 such as a rotary valve or auger, for example, can be used to regulate the transfer rate of the coarser dried biomass from the bottom of the drying chamber 12. A gas exit 27 such as a hood-type arrangement with a perforated plate or screen can be provided at the bottom of the drying chamber. Such an arrangement can facilitate good gas-solid contact for drying. A vent 28 can be provided for gas escape from the coarse material catchpot 30; this vent 28 can be connected to the inlet of the primary cyclone 18. As shown, fines can be recirculated from the cyclone catch 24 to the pulse combustor 10 to generate the flue gas and the pulsating flow field, with a fuel inlet 29 to allow natural gas or propane to be used for startup and support, if necessary.

In another embodiment, the pulsed dryers of the present invention can be pulsed fluid bed dryers. In general, a fluid bed design can be utilized for drying systems in which the biomass feed includes larger particles, for example, particles up to about 2 inches or about 50 mm in size.

The utilization of a drying system including a fluid bed coupled to a pulse combustor can offer many advantages over conventional dryers. For instance, a fluid bed design can provide for vigorous solids mixing, superior heat and mass transfer characteristics, as well as excellent temperature uniformity in the bed. In addition, utilization of a fluid bed can avoid caking, particle sticking, or lump formation due to particle separation and suspension in the drying fluid. Fluid bed designs can also provide for separation of feedstock into coarse and fine fractions in the drying chamber as well as increased safety due to the tempered environment and ability to operate the process below the minimum ignition temperature of the biomass. In addition, fluid bed designs can be highly flexible and allow for a great deal of variation in feedstock as well as good control of particle elutriation. Other advantages of fluid bed designs include low emissions as well as a relatively compact size due to enhanced drying rate per unit volume.

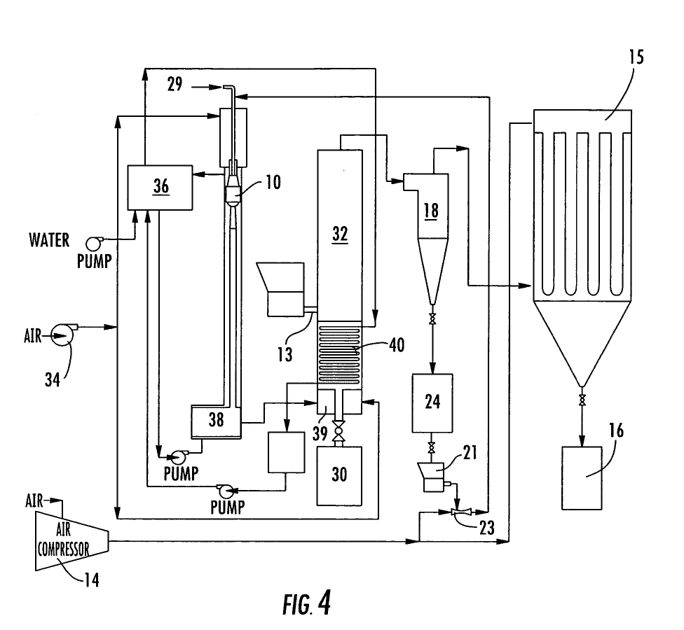

FIG. 4 schematically illustrates one embodiment of a pulsed fluid bed dryer according to the present invention. In this particular embodiment, the drying chamber is a fluidized bed 32 and the wet feedstock subsystem inlet 13 can be located in the splash zone of the bed 32. As the elutriable fines fraction in the wet feedstock increases, the elevation of the feed inlet 13 above the distributor should decrease and move from the splash zone towards the distributor to improve fines residence time in the bed and in turn the drying effectiveness. A forced draft (FD) fan 34 can supply pilot air, combustion air and tempering air to the system. The pulse combustor 10 can comprise a single aerovalve and a single tailpipe and can operate in the dry ash rejection or non-slagging mode. The pulse combustor 10 can also include a pilot burner firing propane or natural gas fed to the system via fuel inlet 29 to ensure ignition of the recirculated biomass fines as well as flame safety. For large capacity dryers, the pulse combustor can incorporate multiple aerovalves and multiple tailpipes, as necessary.

Optionally, the pulsed dryers of the invention can include a steam/water circuit to provide heating and cooling to various portions of the system. For example, in the embodiment illustrated in FIG. 4, the pulse combustion chamber and/or the tailpipe of the pulse combustor 10 can be cooled with water pulled off of steam drum 36. Water cooling of the tailpipe can limit the combustion zone temperature to less than the ash softening temperature (e.g., about 2,000° F.). Alternately, the cooling medium may be air or a heat transfer fluid or thermofluid, specific examples of which being generally known in the art.

A decoupler 38 between the pulse combustor 10 and the fluid bed 32 can provide the transition from the tailpipe of the pulse combustor 10 to the fluid bed inlet plenum 39. The decoupler 38 can act as an acoustic decoupling or disengaging chamber and can also provide additional residence time for the flue gases and particulates generated in the pulse combustor to ensure completion of combustion of the biomass char fines. The decoupler 38 can generally have a quasi-cyclonic design to complete the char burnout and reduce the fines carryover in the flue gas. According to this particular embodiment, the decoupler 38 can be water cooled in the same circuit as the pulse combustor 10. In one embodiment, the decoupler 38 can be of a membrane wall-type construction. Generally, forced circulation can be employed to circulate water from the steam drum 36 through the decoupler 38 and the pulse combustor 10 cooling jackets and back to the steam drum 36. Alternately, the cooling medium may be air or a heat transfer fluid or thermofluid.

Steam from the steam drum 36 can also be routed through a fluidized heating module 40 which can function as an indirect heat exchanger to supply heat to the drying zone of the fluidized bed 32. This can help reduce the air demand in the bed and in turn the size, cost and power consumption of the FD fan 34 as well as the fluidized bed vessel cross-section and cost. For example, the heating module 40 can be a coil or bayonet type tubular heat exchanger. The design steam pressure off of the steam drum 36 can generally be low (about 125 psig, in one embodiment) and can be selected such that the saturation temperature is on the order of the safe inlet temperature (SIT) for the feedstock (SIT may be 10 to 25° C. lower than the minimum ignition temperature of the dried feedstock). The SIT can generally vary depending upon the particular characteristics of the biomass feedstock. For example, in one embodiment, the SIT can be less than about 750° F. In another embodiment, the SIT can be less than about 500° F., for example, between about 350° F. and about 400° F. As can be seen, the condensed steam can be recirculated to the steam drum 36.

Tempering air from the FD fan 34 can be added to the fluid bed inlet plenum 39 to regulate the flue gas temperature at the fluidized bed inlet to SIT. The particular fluidized bed design will be a function of the biomass feedstock properties (particle size distribution, shape, density, HHV and initial moisture content) and the drying demand (final moisture content). For example, the quantity of fines required to fire the pulse combustor can influence the superficial fluidization velocity that in turn dictates the vessel cross-section or diameter.

The bed height can be low, medium or high, and preferential bed height will generally be determined by the particular process characteristics. A shallow bed generally can reduce fan static head and power requirements, and bubbles are also smaller relatively and result in reduced gas bypassing and better heat and mass transfer characteristics. But when considering a shallow bed, the gas and solids residence times are reduced as well. Conversely, a deep bed can offer increased residence times, but at the cost of additional fan power, slugging potential and increased entrainment of bed solids. In one embodiment, a moderate bed height and a freeboard gas residence time on the order of 2 seconds can be employed.

In one embodiment, a cyclone 18 can be employed as the primary particle separator. Cyclone 18 can be utilized to collect biomass fines for pulse combustion and allow the fly ash from pulse combustion to go through to the baghouse 15. Here again, the preferred design for any particular embodiment can depend on the biomass feedstock properties and the drying demand.

A volumetric or screw feeder can be utilized to meter and feed the wet biomass at 13 into the splash zone of the fluidized bed 32. Alternately gravimetric or ram-type feeders may be employed. In other embodiments, multiple feeder/feedpoint configurations can be utilized. Another screw feeder at the dried fines feeder 21 and an eductor 23 can be utilized to meter and convey the biomass fines to the pulse combustor 10. An air compressor 14 can be included to supply the motive air for the eductor 23 as well as for the backflushing or pulse jet-cleaning air for the baghouse 15.

A computer-based control system can optionally be included in the disclosed systems that can permit fully automatic start-up with system purge and ignition verification.

In one embodiment, the disclosed system can be an efficient, economical, and environmentally acceptable biomass fines-fired pulse combustor. This system can fire the ultrafine fraction to generate flue gas. The pulse combustor can operate either substoichiometrically or fuel-rich followed by staged air addition to minimize NOₓ emissions. The NOₓ emissions can, in one embodiment, be less than 0.11 b/MMBtu. The peak combustion temperature can be regulated so as to not exceed the ash softening temperature by utilizing a cooling air jacket, water jacket, or heat transfer fluid jacket design.

Specific benefits of the disclosed pulsed drying systems can include:
Energy savings and improved throughput
Superior heat and mass transfer rates that reduce required temperature differences/irreversibility and enhance drying rates. This together with the low excess air operation can translate into lower energy consumption and greater throughput as compared to conventional dryers.
Enhance product quality
Good mixing and intimate gas-solid contact provide for temperature uniformity and in turn consistent product quality.
Safety
The tempered environment renders it safe for processing delicate, flammable and heat-sensitive feedstock.
Feedstock flexibility
Can accommodate many different classes of material such as granular and crystalline solids and powders, slurries, pastes, and sludges.
Minimal maintenance
No mechanical moving parts or high velocity two-phase flow other than fans/blowers and solids feeders and/or low-pressure pump.
Clean
Pulse combustion ensures low gaseous emissions (NOₓ, CO, and THC)
Cost-Effective
Energy efficiency and compact arrangement reduce life cycle, i.e., capital and operating costs, as compared to that for conventional dryers
Enhance the utilization of a renewable energy and thereby refrain from aggravating the global climate change
Provide a “green” technology for markets which have non-fossil mandates
Cater to fuel and power demand, especially in remote rural areas in the U.S. and local areas of developing countries which lack premium fuel, transportation infrastructure and have limited biomass supply due to short economical transportation radius
Amendable to modularity and mass production
Generate additional tax revenue and promote economic development
Reduce crude oil imports

Based on current estimates of energy consumption, it seems reasonable to assume an annual world energy growth of 5 Quad Btu. If 2% of this growth is powered by biomass, and 5% of this biomass contribution is from the incorporation of the disclosed drying systems, assuming the nominal moisture content of the wet biomass is 50%, the moisture content after drying is 10%, and the average unit capital cost is $150 per lb/h of moisture evaporated, then the gross revenue can be estimated to be about 10 million dollars per annum. A nominal 25% reduction in energy consumption by use of this system in comparison to conventional dryers can lead to a savings in energy to the tune of 300 billion Btu per year.

The present invention can be better understood with reference to the following examples:

### EXAMPLE 1

Burners were tested in three different configurations: a pulse burner (0.76 to 5.58 million Btu/h firing rate range) retrofitted to a Cleaver-Brooks boiler and two versions of a pulse combustor from 2 to 9 million Btu/h including a 72-tube heater/heat exchanger bundle of the type used in steam-reforming process. In all cases, the NOₓ emissions measured when firing natural gas were less than 30 ppmv @ 3% O₂. Emissions Data from the retrofitted Cleaver-Brooks boiler is graphically illustrated in FIG. 5. Emissions data from a pilot-scale 72-tube heater/heat exchanger bundle that had already accumulated more than 5,000 hours of operation was measured by several instruments and organizations as listed below and is presented in Table 2.

TABLE 2
Emissions Data from the 72-Tube Pilot-Scale Pulse Heater Tests

| | | | | SO CAL | | | | | |
|---|---|---|---|---|---|---|---|---|---|
| | LAND | | | GAS | | | CAL POLY | | |
| | COMBUSTION | | | ENERAC | | | BACHARA | | |
| | FLUE | | Corrected | FLUE | | Corrected | CH FLUE | | Corrected |
| FIRING | READINGS | | @ 3% O₂ | READINGS | | @ 3% O₂ | READINGS | | @ 3% O₂ |
| RATE | O₂ | NOₓ | NOₓ | O₂ | NOₓ | NOₓ | O₂ | NOₓ | NOₓ |
| MMBtu/h | (%) | (ppm) | (ppm) | (%) | (ppm) | (ppm) | (%) | (ppm) | (ppm) |
| 1.73 | 13.9 | 2 | 5.1 | 13.8 | 6 | 15.0 | 13.6 | 0 | 0 |
| 1.74 | 16.1 | 1 | 3.7 | 16.3 | 0 | 0 | 15.9 | 0 | 0 |
| 3.39 | 13.4 | 2 | 4.7 | 13.6 | 4 | 9.7 | — | 0 | 0 |
| 3.39 | 14.8 | 1 | 2.9 | 16.7 | 0 | 0 | 16.3 | 0 | 0 |
| 3.39 | 16.5 | 1 | 4.0 | 9.4 | 11 | 17.1 | — | — | — |
| 5.10 | 8.8 | 17 | 25.1 | 8.8 | 22 | 32.5 | — | — | — |
| 5.10 | 11.1 | 14 | 25.1 | — | — | — | 8.6 | 16 | 23.2 |

### EXAMPLE 2

A process unit for a nominal 100 lb/h moisture evaporation capacity was designed, fabricated and installed. The system configuration corresponds to that shown in FIG. 2. Limited testing was carried out with a slurry. The pulse combustor was fired with natural gas at a rate of 212 kBtu/h. The slurry feed rate was 147 lb/h with 21% solids by weight. The test was successful in producing dry, dust-free, free-flowing solids. Good mass balance was achieved with regard to solids and there were no wall deposits or mud rings. The specific energy consumption on a gross basis was computed to be 1,827 Btu/lb of water evaporated. Heat losses however were found to be significant due to the high surface area per unit volume of the drying system on account of the small size of the unit and inadequate insulation. A first-order estimate projected the heat loss to be on the order of 400 Btu/lb of water evaporated. Therefore, the net specific energy consumption was in the 1,400 to 1,500 Btu/lb range. The total gas flow in the exemplary systems was a fraction (⅓ to ½) of those from conventional dryers.

### EXAMPLE 3

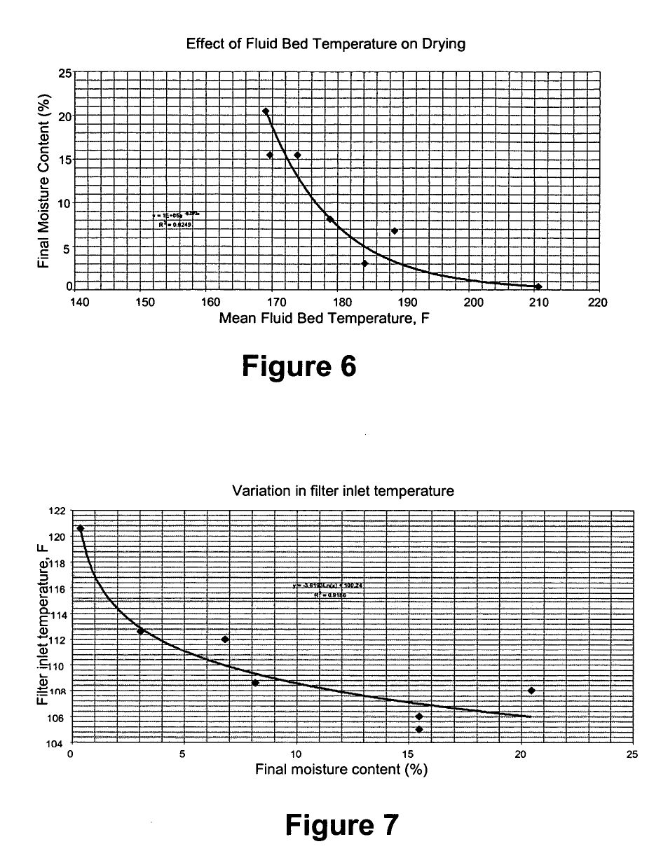

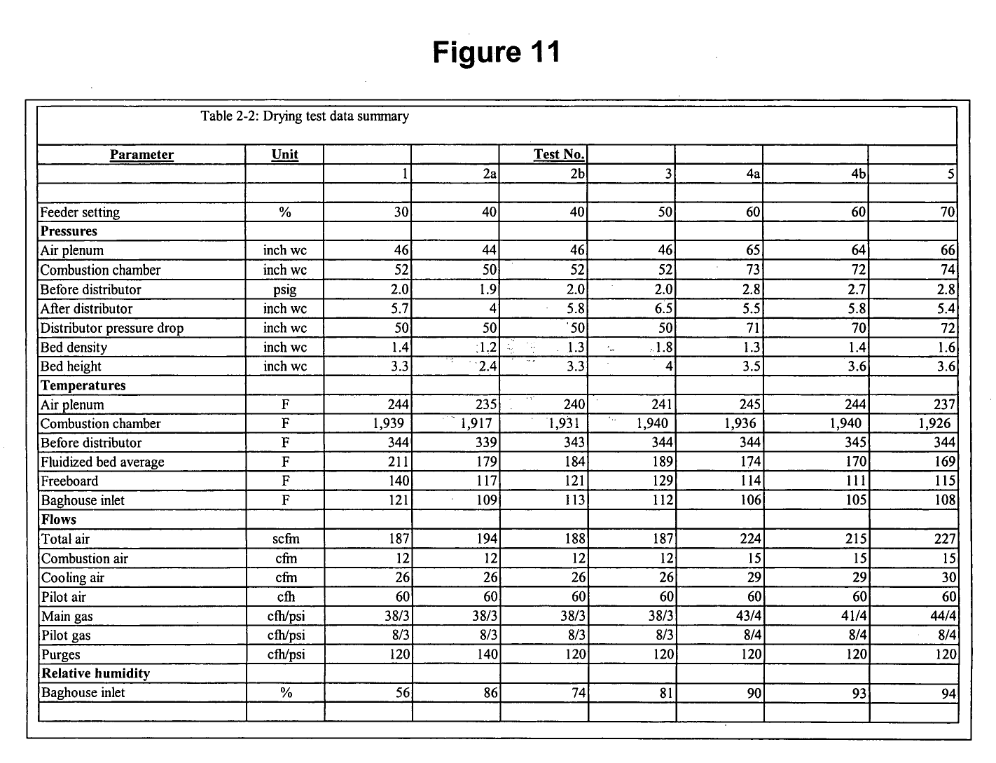

Five samples of sawdust slurries were run in a pulsed fluid bed dryer similar to that illustrated in FIG. 4. Samples varied according to biomass feed rate. Duplicate samples were taken during two tests to check repeatability. The time-averaged test data are provided in FIG. 11. The biomass feed rate ranged between 50 and 115 lb/h. The pulse combustor firing rate ranged between 65 and 80 kBtu/h. The pulse combustor fuel was natural gas during these tests. Even though the pulse combustor was operating between 30 and 40% of its design firing rate, the pressure boost was significant and ranged between 6 and 8 inch wc. The pulse combustion chamber temperature was in the 1,900s and the flue gas inlet temperature to the fluid bed distributor was on the order of 340° F. The average expanded fluid bed height was calculated based on pressure drop for a known height i.e. bed density and total bed pressure drop measurements. It varied between 22 and 29 inches for the different tests. The superficial fluidization velocity was calculated from the measurements and it ranged between 2.3 and 2.7 ft/s. The wet biomass feed moisture content spanned the range from 52 to 58% by weight. The final moisture content of the bed drain product ranged from a very dry (0.4% moisture content) to moderately dry (˜20% moisture content). The average fluid bed temperature varied with feed rate and final moisture content and ranged from a low of 169° F. to a high of 211° F. It exhibited an increasing trend with a decrease in final moisture content as shown in FIG. 6. This is consistent with the fact that a higher bed temperature or driving potential is necessary to enhance heat and mass transfer rates and in turn the degree of particle drying.

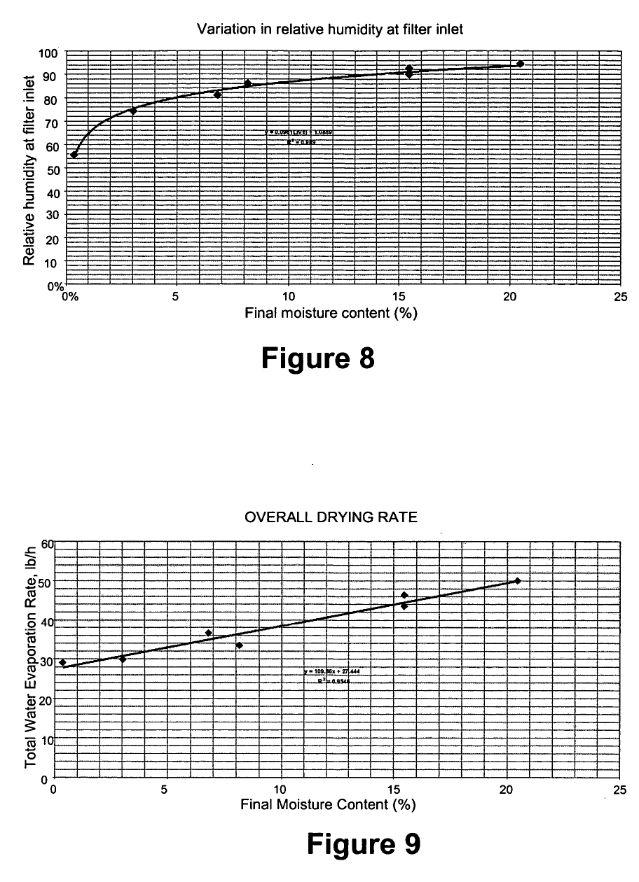

FIGS. 7 and 8 indicate the variation in bag filter inlet temperature and relative humidity respectively. With an increase in final moisture content, the temperature decreases and the humidity increases. The humidity increase is attributed to a higher degree of saturation at lower temperatures. The lower filter inlet temperature is a consequence of a decrease in fluid bed temperature with an increase in final moisture content. The pressure drop across the bag filter was low and on the order of 2 inch wc.

The variation in overall drying rate or total water evaporation rate is shown in FIG. 9 as a function of the final moisture content. This rate exhibits an increase from 29 to 50 lb/h with an increase in final moisture content. The high rate is characteristic of constant rate or stage 1 drying while the low rate is a consequence of stage 2 or falling rate period or diffusion dependent drying.

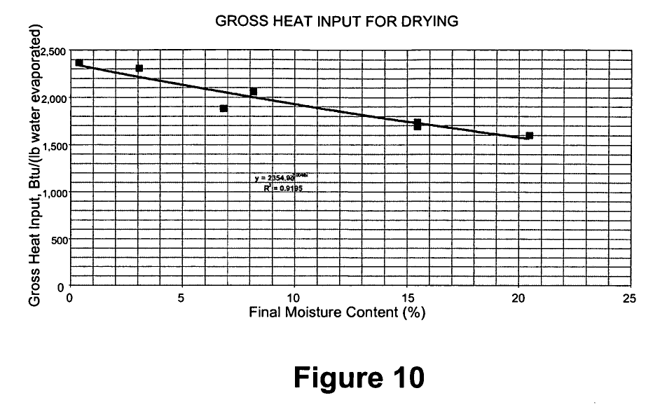

Dividing the total natural gas firing rate by the total water evaporation rate, the gross heat input for drying was computed. This is shown in FIG. 10 as a function of final moisture content. As is to be expected, the heat input required decreases with an increase in final moisture content. This is because the required driving potential decreases i.e. the average fluid bed operating temperature decreases and the humidity ratio approaches saturation value with an increase in moisture content.

Draeger tube measurements of the flue gas were made after the pulse combustor operation was stable but prior to the start of the biomass feed or after stopping the feed to minimize interference from moisture. The data indicated the following levels, all in ppmv:
CO₂—6,300 to 6,800;
CO—2 to 3;
NOₓ—1 to 2 and
THC—0.
O₂—on the order of 19.5%.

Combustion and tempering calculations estimated the CO₂ level to range between 6,000 and 6,300 ppmv and the O₂ to range between 19.48 and 19.54% in the flue gas. This suggests excellent mass balances for the gas species. Moisture balance for the tests indicated the measured relative humidity to be within 10% of that calculated. Energy balance calculations indicated the heat loss from the dryer to range between 5 and 30% of the total gas firing rate. The 5% value corresponded to the highest feed rate/final moisture content/firing rate while the 30% corresponded to the lowest feed rate/final moisture content/firing rate. This is consistent with the fact that the flue gas tempering section and the fluidized dense bed were not insulated, the fluidized bed operating temperature and in turn the heat loss climbed higher as the feed rate got lower, and the firing rate and final moisture content increased with feed rate.

The bed drain and filter catch products were all found to be dry, non-sticky and free flowing. The filter catch seemed to have pin/needle shape. The longitudinal dimension was estimated to have a top size of 0.05 inch (1,270 microns) and a mean size of about 0.025 inch (635 microns). Based on the estimated fluidization velocity and the particle terminal velocity calculations, the aerodynamic equivalent mean particle size turned out to be on the order of 300 microns.

It will be appreciated that the foregoing examples, given for purposes of illustration, are not to be construed as limiting the scope of this invention. Although only a few exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention that is defined in the following claims and all equivalents thereto. Further, it is recognized that many embodiments may be conceived that do not achieve all of the advantages of some embodiments, yet the absence of a particular advantage shall not be construed to necessarily mean that such an embodiment is outside the scope of the present invention.

1. A dryer comprising:
a drying chamber for drying a liquid or slurry feed comprising biomass or organic waste;
a pulse combustor fluid-dynamically coupled to the drying chamber, wherein flue gas from the pulse combustor flows through the drying chamber and creates a pulsating velocity head in the drying chamber for drying the biomass, wherein the dried biomass comprises biomass fines; and
a path for feeding dried biomass or organic waste fines to the pulse combustor as fuel.

2. The dryer of claim 1, wherein the pulse combustor is acoustically coupled to the drying chamber.

3. The dryer of claim 1, the drying chamber comprising a feed inlet downstream of the pulse combustor, wherein a liquid or slurry feed is atomized by the pulse combustor flue gas.

4. The dryer of claim 1, wherein the drying chamber is a fluidized bed, wherein the feedstock is fed into the dense bed region or into the splash zone.

5. The dryer of claim 1, wherein the pulse combustor is coupled to the dryer via a resonance tube.

6. The dryer of claim 4, further comprising a heat exchanger for providing heat to the drying chamber.

7. A drying system comprising:
a feed inlet for conveying a liquid or slurry feedstock comprising biomass or organic waste;
a drying chamber for receiving the feedstock;
a product outlet for removing dried biomass or organic waste from the drying chamber; and
a pulse combustor fluid dynamically coupled to the drying chamber via a pulse combustor tailpipe.

8. The drying system of claim 7, further comprising one or more solids separation devices for separating biomass fines from the dried biomass.

9. The drying system of claim 8, further comprising a circulation system for feeding the dried product fines to the pulse combustor.

10. The drying system of claim 7, wherein the feed inlet is downstream of the pulse combustor such that a wet feedstock is atomized by the flue gas from the pulse combustor.

11. The drying system of claim 7, wherein the drying chamber is a fluidized bed; the pulse combustor being fluid dynamically coupled to the drying chamber via the inlet plenum of the fluidized bed.

12. The drying system of claim 11, wherein the feed inlet conveys a feedstock to the splash zone of the fluid bed or into the dense fluid bed.

13. The drying system of claim 11, wherein the feedstock comprises particles up to about two inches in diameter.

14. The drying system of claim 7, further comprising an indirect heating circuit for circulating a heat transfer fluid for providing heat to the drying chamber.

15. The drying system of claim 14, the heating circuit also being for removing heat from the pulse combustor tailpipe or the pulse combustion chamber.

16. The drying system of claim 14, wherein the indirect heating circuit circulates water and steam.

17. The drying system of claim 14, wherein the heat transfer fluid is a gas.

18. The drying system of claim 17, wherein the heat transfer fluid is air.

19. The drying system of claim 14, wherein the heat transfer fluid is a thermofluid.

20. The drying system of claim 7, wherein the dried product is less than about 20% moisture.

21. The drying system of claim 7, wherein the dried product is less than about 15% moisture.

22. The drying system of claim 7, wherein the dried product is less than 10% moisture.
